(19) United States
(12) Patent Application Publication
(10) Pub. No.: US 2013/0120359 A1
(43) Pub. Date: May 16, 2013

(54) METHOD AND SYSTEM FOR CONTROLLING SYNCHRONIZATION OF 3D SHUTTER GLASSES

(71) Applicants: Mao-Jung Chung, Tainan City (TW); Shwang-Shi Bai, Tainan City (TW); Kuo-Jung Li, Tainan City (TW); Chien-Jung Chen, Tainan City (TW); I-Sheng Lin, Tainan City (TW)

(72) Inventors: Mao-Jung Chung, Tainan City (TW); Shwang-Shi Bai, Tainan City (TW); Kuo-Jung Li, Tainan City (TW); Chien-Jung Chen, Tainan City (TW); I-Sheng Lin, Tainan City (TW)

(73) Assignee: HIMAX DISPLAY, INC., Tainan City (TW)

(21) Appl. No.: 13/295,726

(22) Filed: Nov. 14, 2011

(51) Int. Cl. G06T 15/00

(52) U.S. Cl. 345/419

(57) ABSTRACT

A method for controlling synchronization of a 3D shutter glasses adapted to a system for controlling synchronization of the 3D shutter glasses is provided. The method includes the following steps. A plurality of synchronous images of a 3D image projected on a screen are sensed by an image sensor of the shutter glasses. The 3D image includes a plurality of left images and right images and the synchronous images. The left images and the right images are respectively synchronized with a left-eye liquid crystal shutter and a right-eye liquid crystal shutter of the 3D shutter glasses based on the sensing result when the left-eye liquid crystal shutter and the right-eye liquid crystal shutter are respectively turned on. Furthermore, a system for controlling synchronization of the 3D shutter glasses using this method is also provided.

### BACKGROUND OF THE INVENTION

1. Field of the Invention

The invention relates to a method for processing images and a system using the same, and more particularly to a method for controlling synchronization of a 3D shutter glasses and a system using the same.

2. Description of Related Art

As technology advances and develops, people's eagerness for better material life and spiritual life are increasing without a pause. When it comes to the spiritual life, in the world of technology, most people have the desire to realize their imagination and to experience it vividly with the help of stereo display apparatuses. For this reason, how to develop stereo display apparatuses suitable for displaying three-dimensional (3D) images has become the goal for manufacturers in the field.

For a 3D projection system, a 3D projector projects a plurality of successive two-dimensional (2D) images onto a screen, and then users can see 3D images by wearing a shutter glasses. The 3D images are formed by the projected 2D images comprising left images and right images. The left images and right images respectively pass through a left-eye liquid crystal shutter and a right-eye liquid crystal shutter of the shutter glasses. By turning on and off the left-eye and right-eye liquid crystal shutters, the left images and right images can respectively be projected into left eyes and right eyes of human beings, and thus the 3D images can be formed. Accordingly, how to synchronizing the left images and right images respectively with the left-eye and right-eye liquid crystal shutters of the shutter glasses is an important issue.

### SUMMARY OF THE INVENTION

The invention is directed to a method for controlling synchronization of a 3D shutter glasses and a system using the same, capable of synchronizing images with liquid crystal shutters by an image sensor of the shutter glasses.

The invention provides a system for controlling synchronization of a 3D shutter glasses. The system includes a screen, a projector, and a 3D shutter glasses. The projector projects a 3D image on the screen. The 3D image includes a plurality of left images, right images, and synchronous images. The 3D shutter glasses includes a left-eye liquid crystal shutter, a right-eye liquid crystal shutter, and an image sensor. The left images pass through the left-eye liquid crystal shutter when the left-eye liquid crystal shutter is turned on. The right images pass through the right-eye liquid crystal shutter when the right-eye liquid crystal shutter is turned on. The image sensor senses the synchronous images such that the left images and the right images are respectively synchronized with the left-eye liquid crystal shutter and the right-eye liquid crystal shutter based on the sensing result when the left-eye liquid crystal shutter and the right-eye liquid crystal shutter are respectively turned on.

The invention provides a method for controlling synchronization of a 3D shutter glasses adapted to a system for controlling synchronization of the 3D shutter glasses. The system includes a screen, a projector, and a 3D shutter glasses. The 3D shutter glasses includes a left-eye liquid crystal shutter, a right-eye liquid crystal shutter. The method includes the following steps. A plurality of synchronous images of a 3D image projected by the projector are sensed by the image sensor of the 3D shutter glasses. The 3D image includes a plurality of left images, right images, and synchronous images. The left images pass through a left-eye liquid crystal shutter of the 3D shutter glasses. The right images pass through a right-eye liquid crystal shutter of the 3D shutter glasses. The left images and the right images are respectively synchronized with the left-eye liquid crystal shutter and the right-eye liquid crystal shutter based on the sensing result when the left-eye liquid crystal shutter and the right-eye liquid crystal shutter are respectively turned on.

In an embodiment of the invention, the left images and the right images are alternately arranged, and the synchronous images are inserted between the left images and the right images.

In an embodiment of the invention, the synchronous images include a plurality of first synchronous images and second synchronous images, and the first synchronous images and the second synchronous images are alternately arranged.

In an embodiment of the invention, each of the first synchronous images is a completely bright image.

In an embodiment of the invention, each of the second synchronous images includes at least one bright area and at least one dark area.

In an embodiment of the invention, each of the second synchronous images is a completely dark image.

In an embodiment of the invention, the image sensor senses the completely bright images without sensing the completely dark images. The 3D shutter glasses further includes a counting unit. The counting unit generates a count value during a time period between neighboring two of the completely bright images, and the left images and the right images are respectively synchronized with the left-eye liquid crystal shutter and the right-eye liquid crystal shutter further based on the count value.

In an embodiment of the invention, each of the first synchronous images includes at least one left synchronous pattern, and each of the second synchronous images includes at least one right synchronous pattern.

In an embodiment of the invention, the 3D shutter glasses further includes a control unit. The control unit identifies the left synchronous patterns and the right synchronous patterns to distinguish the first synchronous images from the second synchronous images, and the left images and the right images are respectively synchronized with the left-eye liquid crystal shutter and the right-eye liquid crystal shutter further based on an identification result.

In an embodiment of the invention, the step of sensing the synchronous images includes the following step. The completely bright images are sensed without sensing the completely dark images.

In an embodiment of the invention, the image synchronization method further includes the following step. A count value is generated during a time period between neighboring two of the completely bright images by a counting unit of the 3D shutter glasses. The left images and the right images are respectively synchronized with the left-eye liquid crystal shutter and the right-eye liquid crystal shutter based on the count value.

In an embodiment of the invention, the image synchronization method further includes the following step. The left synchronous patterns and the right synchronous patterns are identified to distinguish the first synchronous images from the second synchronous images. The left images and the right images are respectively synchronized with the left-eye liquid crystal shutter and the right-eye liquid crystal shutter based on an identification result.

According to the above descriptions, the method for controlling synchronization of the 3D shutter glasses is performed in a 3D projection system to respectively synchronize the left images and the right images with the left-eye liquid crystal shutter and the right-eye liquid crystal shutter based on the sensing result of the image sensor of the shutter glass. Therefore, extra receiving or transmitting signals associated with image synchronization is unnecessary.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic diagram of a 3D projection system according to an embodiment of the invention.

FIG. 2 illustrates a schematic diagram of the shutter glasses in FIG. 1 according to an embodiment of the invention.

FIG. 3 illustrates a schematic diagram of the 3D image projected on the screen which comprise a plurality of 2D images according to an embodiment of the invention.

FIG. 4 illustrates a flowchart of a method for controlling synchronization of a 3D shutter glasses according to an embodiment of the invention.

FIG. 5 illustrates different variations of the 3D images which comprise 2D images successively projected onto the screen according to an embodiment of the invention.

FIG. 6 illustrates a flowchart of a method for controlling synchronization of a 3D shutter glasses according to another embodiment of the invention.

FIG. 7 illustrates a flowchart of a method for controlling synchronization of a 3D shutter glasses according to another embodiment of the invention.

### DESCRIPTION OF EMBODIMENTS

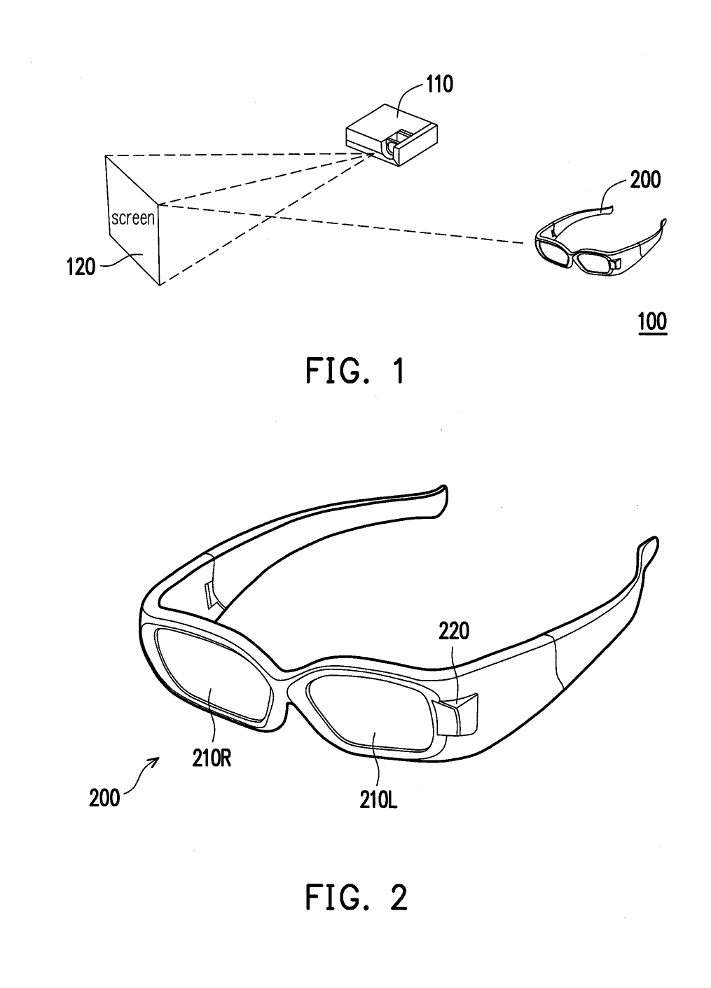

FIG. 1 illustrates a schematic diagram of a 3D projection system according to an embodiment of the invention. Referring to FIG. 1, the 3D projection system 100 of the present embodiment includes a 3D projector 110, a screen 120, and a 3D shutter glasses 200. Herein, the 3D projection system 100 is exemplary for the system for controlling synchronization of a 3D shutter glasses. The 3D projector 110 projects a plurality of 2D images onto the screen 120, and the 2D images received by a user wearing the 3D shutter glasses 200 would form a 3D image later. In the present embodiment, the 3D image includes a plurality of synchronous images. By sensing the synchronous images, the left images and right images are respectively synchronized with the left-eye and right-eye liquid crystal shutters of the 3D shutter glasses 200 based on the sensing result. A good 3D image quality is provided.

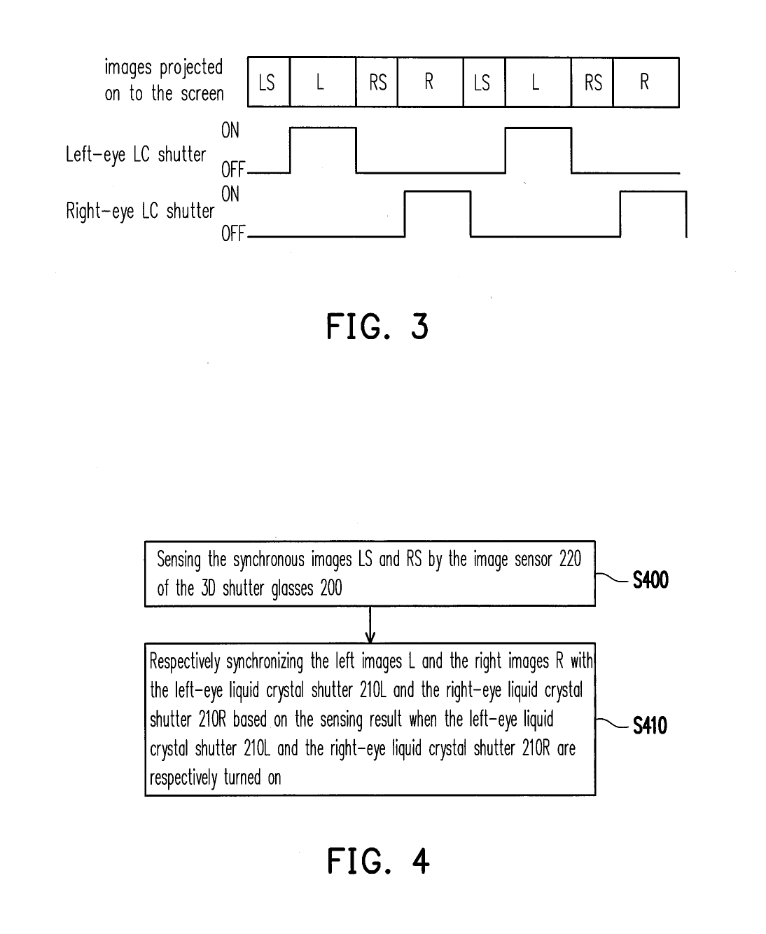

Specifically, FIG. 2 illustrates a schematic diagram of the shutter glasses in FIG. 1 according to an embodiment of the invention. FIG. 3 illustrates a schematic diagram of the 3D image projected on the screen 120 which comprise a plurality of 2D images according to an embodiment of the invention. Referring to FIG. 1 to FIG. 3, the 3D shutter glasses 200 of the present embodiment includes a left-eye liquid crystal shutter 210L, a right-eye liquid crystal shutter 210R, and an image sensor 220. In the present embodiment, the 3D image as shown in FIG. 3 includes a plurality of left images L, right images R, and synchronous images LS and RS. The left images L and the right images R are alternately arranged, and the synchronous images LS and RS are inserted therebetween. The left images L and the right images R respectively pass through the left-eye liquid crystal shutter 210L and the right-eye liquid crystal shutter 210R of the 3D shutter glasses 200 when they are turned on respectively. The synchronous images LS and RS are projected for synchronization, and the projection frequency of the synchronous images LS and RS is fast enough that users do not see the projected synchronous images LS and RS.

FIG. 3 also shows waveforms of control signals which control the left-eye liquid crystal shutter 210L and the right-eye liquid crystal shutter 210R to be turned on or off. When the control signal for controlling the left-eye liquid crystal shutter 210L goes high, the left-eye liquid crystal shutter 210L is turned on such that the left images L pass through the left-eye liquid crystal shutter 210L and are displayed into users' left eyes. It should be noted that the right-eye liquid crystal shutter 210R is turned off at this time. Next, the control signal for controlling the left-eye liquid crystal shutter 210L goes low, and the control signal for controlling the right-eye liquid crystal shutter 210R goes high. Similarly, the right-eye liquid crystal shutter 210R is turned on such that the right images R pass through the right-eye liquid crystal shutter 210R and are displayed into users' right eyes. By alternately displaying the left images L and the right images R respectively into the users' left and right eyes, the users would see the associated 3D images. Accordingly, exactly synchronizing images with liquid crystal shutters is important when the liquid crystal shutters are respectively turned on.

In the present embodiment, the synchronous images LS and RS are configured to synchronize the images L and R with the liquid crystal shutters 210L and 210R of the 3D shutter glasses 200. Herein, the synchronous images LS and RS comprises a plurality of first synchronous images LS and second synchronous images RS. The first synchronous images LS and the second synchronous images RS are inserted between the left images L and the right images R and alternately arranged. The image sensor 220 of the 3D shutter glasses 200 senses the synchronous images LS and RS such that the left images L and the right images R are respectively synchronized with the left-eye liquid crystal shutter 210L and the right-eye liquid crystal shutter 210R based on the sensing result when they are respectively turned on. Extra receiving or transmitting signals associated with image synchronization is unnecessary.

FIG. 4 illustrates a flowchart of a method for controlling synchronization of a 3D shutter glasses according to an embodiment of the invention. Referring to FIG. 1 to FIG. 4, the image synchronization method of the present embodiment, for example, is adapted to the 3D display system 100 as shown in FIG. 1. The 3D projector 110 projects the 3D image comprising the left images L, the right images R, and the synchronous images LS and RS as shown in FIG. 3 onto the screen 120. In this method, the synchronous images LS and RS projected by the projector 110 are first sensed by the image sensor 220 of the 3D shutter glasses 200 in step S400. Next, in step S410, the left images L and the right images R are respectively synchronized with the left-eye liquid crystal shutter 210L and the right-eye liquid crystal shutter 210R based on the sensing result when the left-eye liquid crystal shutter 210L and the right-eye liquid crystal shutter 210R are respectively turned on. In this way, exactly synchronizing the images with the liquid crystal shutters is performed when the liquid crystal shutters are respectively turned on.

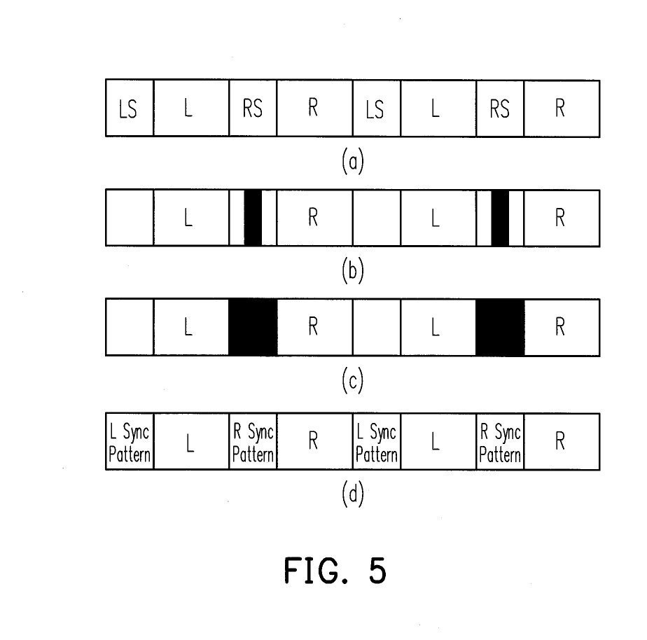

FIG. 5 illustrates different variations of the 3D images which comprise 2D images successively projected onto the screen according to an embodiment of the invention. Referring to FIG. 3 to FIG. 5, FIG. 5(a) shows the 3D image comprising the left images L, the right images R, and the synchronous images LS and RS of which the configuration is identical with that of FIG. 3. That is, the left images L and the right images R are alternately arranged, and the synchronous images LS and RS are inserted therebetween and alternately arranged.

In an exemplary variation of the 3D image such as FIG. 5(b), each of the first synchronous images LS may be a completely bright image, and each of the second synchronous images RS may comprise at least one bright area and at least one dark area. In FIG. 5(b), each of the second synchronous images RS has two bright strips and one dark strip. For a display system based on a color-sequential method, an image having bright strips and dark strips alternately arranged is strongly distinguishable. Accordingly, the image sensor 220 of the 3D shutter glasses 200 senses the first synchronous images LS and the second synchronous images RS, such that the left images L and the right images R are respectively synchronized with the left-eye liquid crystal shutter 210L and the right-eye liquid crystal shutter 210R based on the sensing result when the left-eye liquid crystal shutter 210L and the right-eye liquid crystal shutter 21 OR are respectively turned on.

In another exemplary variation of the 3D image such as FIG. 5(c), each of the first synchronous images LS may be a completely bright image, and each of the second synchronous images RS may be a completely dark image. In this variation, the image sensor 220 senses the completely bright images without sensing the completely dark images. For synchronization, the 3D shutter glasses 200 may further comprise a counting unit (not shown) for generating a count value during a time period between two neighboring completely bright images. In one embodiment of the invention, the counting unit may be combined within the image sensor 220.

To be specific, the counting unit starts to count at the initial time of which a first completely bright image is sensed and stops counting until a second completely bright image is sensed. A count value M is thus obtained. The count value M corresponds to the time period between two neighboring completely bright images, e.g. the first and the second completely bright images. Next, the count value M is divided by 2 to obtain another count value N. At the initial time of which the second completely bright image is sensed, the counting unit starts to count again and stops counting until the count value reaches to N. The time period that the count value reaches to N represents the time period between the second completely bright image and a neighboring completely dark image. The time period between two neighboring completely bright images may defined as a bright image period by the count value M, and the time period between a specific completely bright image and a neighboring completely dark image may defined as a dark image period by the count value N. Based on the count values M and N, controlling synchronization of the 3D shutter glasses 200 is achieved. Accordingly, the image sensor 220 of the 3D shutter glasses 200 senses the first synchronous images LS and the second synchronous images RS, such that the left images L and the right images R are respectively synchronized with the left-eye liquid crystal shutter 210L and the right-eye liquid crystal shutter 210R based on the sensing result and the counting result.

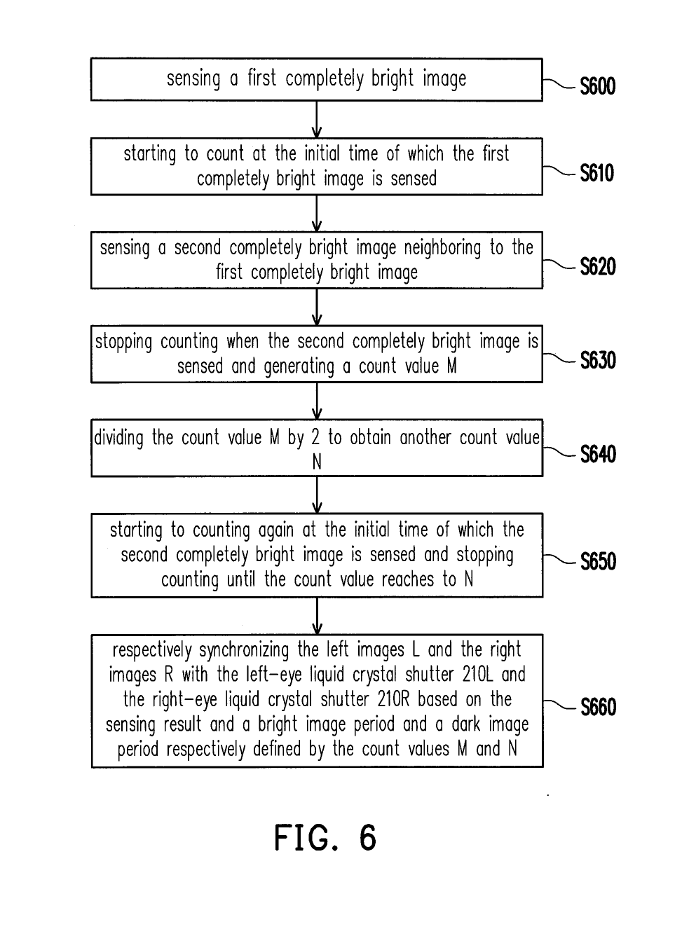

FIG. 6 illustrates a flowchart of a method for controlling synchronization of a 3D shutter glasses according to another embodiment of the invention. Based on the exemplary variation shown in FIG. 5(c), in the present embodiment, the image synchronization method comprises the following steps. In step S600, the image sensor 220 senses a first completely bright image as shown in FIG. 5(c). In step S610, the counting unit starts to count at the initial time of which the first completely bright image is sensed. In step S620, the image sensor 220 senses a second completely bright image as shown in FIG. 5(c). In step S630, the counting unit stops counting when the second completely bright image is sensed. Accordingly, a count value M is generated. In step S640, the count value M is divided by 2 to obtain another count value N. In step S650, the counting unit starts to count again at the initial time of which the second completely bright image is sensed and stops counting until the count value reaches to N. Accordingly, the bright image period defined by the count value M and the dark image period defined by the count value N are obtained. In step S660, the left images L and the right images R are respectively synchronized with the left-eye liquid crystal shutter 210L and the right-eye liquid crystal shutter 210R based on the sensing result and the bright image period and the dark image period respectively defined by the count values M and N.

In another exemplary variation of the 3D image such as FIG. 5(d), each of the first synchronous images may comprise at least one left synchronous pattern, and each of the second synchronous images may comprise at least one right synchronous pattern. In this variation, the image sensor 220 senses the left synchronous patterns and the right synchronous pattern to distinguish the first synchronous images from the second synchronous images. For synchronization, the 3D shutter glasses 200 may further comprise a control unit (not shown) for identifying the left synchronous patterns and the right synchronous patterns such that to the first synchronous images are distinguished from the second synchronous images. Accordingly, the left images L and the right images R are respectively synchronized with the left-eye liquid crystal shutter 210L and the right-eye liquid crystal shutter 210R based on the sensing result and the identification result. In one embodiment of the invention, the control unit may be combined within the image sensor 220.

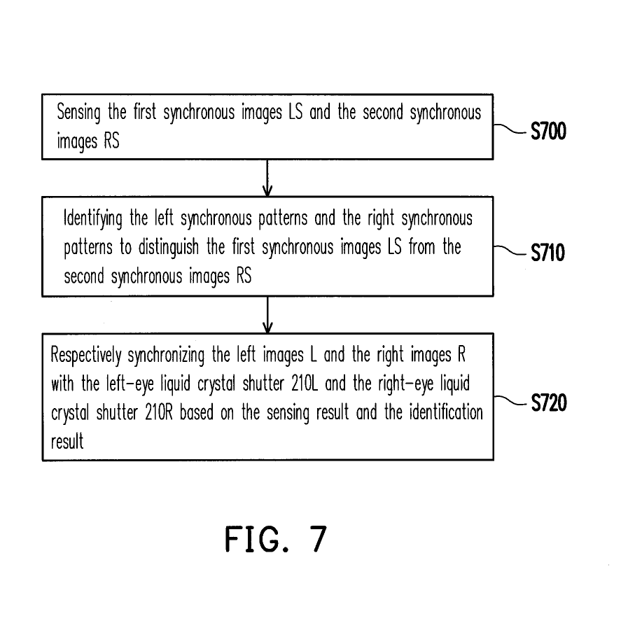

FIG. 7 illustrates a flowchart of a method for controlling synchronization of a 3D shutter glasses according to another embodiment of the invention. Based on the exemplary variation shown in FIG. 5(d), in the present embodiment, the image synchronization method comprises the following steps. In step S700, the first synchronous images LS and the second synchronous images RS as shown in FIG. 5(d) are sensed. In step S710, the left synchronous patterns and the right synchronous patterns are identified to distinguish the first synchronous images LS from the second synchronous images RS. In step S720, the left images L and the right images R are respectively synchronized with the left-eye liquid crystal shutter 210L and the right-eye liquid crystal shutter 210R based on the sensing result and the identification result.

In summary, the method for controlling synchronization of the 3D shutter glasses is performed in a 3D projection system to respectively synchronize the left images and the right images with the left-eye liquid crystal shutter and the right-eye liquid crystal shutter based on the sensing result of the image sensor of the shutter glass. Therefore, extra receiving or transmitting signals associated with image synchronization is unnecessary.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A system for controlling synchronization of a 3D shutter glasses, the system comprising:
a screen;
a projector projecting a 3D image on the screen, wherein the 3D image comprises a plurality of left images, right images, and synchronous images; and
a 3D shutter glasses comprising:
a left-eye liquid crystal shutter, wherein the left images pass through the left-eye liquid crystal shutter when the left-eye liquid crystal shutter is turned on;
a right-eye liquid crystal shutter, wherein the right images pass through the right-eye liquid crystal shutter when the right-eye liquid crystal shutter is turned on; and
an image sensor sensing the synchronous images such that the left images and the right images are respectively synchronized with the left-eye liquid crystal shutter and the right-eye liquid crystal shutter based on the sensing result when the left-eye liquid crystal shutter and the right-eye liquid crystal shutter are respectively turned on.

2. The system as claimed in claim 1, wherein the left images and the right images are alternately arranged, and the synchronous images are inserted between the left images and the right images.

3. The system as claimed in claim 2, wherein the synchronous images comprise a plurality of first synchronous images and second synchronous images, and the first synchronous images and the second synchronous images are alternately arranged.

4. The system as claimed in claim 3, wherein each of the first synchronous images is a completely bright image.

5. The system as claimed in claim 4, wherein each of the second synchronous images comprises at least one bright area and at least one dark area.

6. The system as claimed in claim 4, wherein each of the second synchronous images a completely dark image.

7. The system as claimed in claim 6, wherein the image sensor senses the completely bright images without sensing the completely dark images, and the 3D shutter glasses further comprises:
a counting unit generating a count value during a time period between neighboring two of the completely bright images, and the left images and the right images are respectively synchronized with the left-eye liquid crystal shutter and the right-eye liquid crystal shutter further based on the count value.

8. The system as claimed in claim 3, wherein each of the first synchronous images comprises at least one left synchronous pattern, and each of the second synchronous images comprises at least one right synchronous pattern.

9. The system as claimed in claim 8, wherein the 3D shutter glasses further comprises:
a control unit identifying the left synchronous patterns and the right synchronous patterns to distinguish the first synchronous images from the second synchronous images, and the left images and the right images are respectively synchronized with the left-eye liquid crystal shutter and the right-eye liquid crystal shutter further based on an identification result.

10. A method for controlling synchronization of a 3D shutter glasses, adapted to a system for controlling synchronization of a 3D shutter glasses, wherein the system comprises a screen, a projector, and a 3D shutter glasses, and the 3D shutter glasses comprises a left-eye liquid crystal shutter, a right-eye liquid crystal shutter, and an image sensor, the method comprising:
sensing a plurality of synchronous images of a 3D image projected by the projector by the image sensor of the 3D shutter glasses, wherein the 3D image comprises a plurality of left images passing through the left-eye liquid crystal shutter of the 3D shutter glasses, a plurality of right images passing through the right-eye liquid crystal shutter of the 3D shutter glasses, and the plurality of synchronous images; and
respectively synchronizing the left images and the right images with the left-eye liquid crystal shutter and the right-eye liquid crystal shutter based on the sensing result when the left-eye liquid crystal shutter and the right-eye liquid crystal shutter are respectively turned on.

11. The method as claimed in claim 10, wherein the left images and the right images are alternately arranged, and the synchronous images are inserted between the left images and the right images.

12. The method as claimed in claim 11, wherein the synchronous images comprise a plurality of first synchronous images and a plurality of second synchronous images, and the first synchronous images and the second synchronous images are alternately arranged.

13. The method as claimed in claim 12, wherein each of the first synchronous images is a completely bright image.

14. The method as claimed in claim 13, wherein each of the second synchronous images comprises at least one bright area and at least one dark area.

15. The method as claimed in claim 13, wherein each of the second synchronous images a completely dark image.

16. The method as claimed in claim 15, wherein the step of sensing the synchronous images comprises:
sensing the completely bright images without sensing the completely dark images.

17. The method as claimed in claim 12, further comprising:
generating a count value during a time period between neighboring two of the completely bright images by a counting unit of the 3D shutter glasses, wherein the left images and the right images are respectively synchronized with the left-eye liquid crystal shutter and the right-eye liquid crystal shutter further based on the count value.

18. The method as claimed in claim 12, wherein each of the first synchronous images comprises at least one left synchronous pattern, and each of the second synchronous images comprises at least one right synchronous pattern.

19. The method as claimed in claim 18, further comprises:
identifying the left synchronous patterns and the right synchronous patterns to distinguish the first synchronous images from the second synchronous images, wherein the left images and the right images are respectively synchronized with the left-eye liquid crystal shutter and the right-eye liquid crystal shutter further based on an identification result.
